(19) United States
(12) Patent Application Publication
(10) Pub. No.: US 2025/0177941 A1
(43) Pub. Date: Jun. 5, 2025

(54) SYSTEM FOR CARBONIZING ORGANIC MATERIAL

(71) Applicant: Carbo Culture Oy, Helsinki (FI)

(72) Inventor: Christopher Carstens, Hyde Park, NY (US)

(73) Assignee: Carbo Culture Oy, Helsinki (FI)

(21) Appl. No.: 18/836,977

(22) PCT Filed: Feb. 9, 2023
(86) PCT No.: PCT/FI2023/050079

§ 371 Date: Aug. 8, 2024

(30) Foreign Application Priority Data
Feb. 9, 2022 (EP) 22155933.9

(51) Int. Cl. B01J 8/08; B01J 8/00; C01B 32/348; C10B 53/02

(52) U.S. Cl. CPC B01J 8/085; B01J 8/002; B01J 8/0045; B01J 8/082; B01J 8/087; C01B 32/348; C10B 53/02; B01J 2208/00061; B01J 2208/00176; B01J 2208/00415; B01J 2208/00769; B01J 2208/00884; C01P 2006/40

(57) ABSTRACT

A system for carbonizing organic material is disclosed. A method for carbonizing organic material is also disclosed. Finally, a carbonization product comprising biocarbon formed in the system of the present disclosure or using the method of the present disclosure is further disclosed.

### TECHNICAL FIELD

The present disclosure relates to system for carbonizing organic material. The present disclosure further relates to a method for carbonizing organic material. Finally, the present disclosure also relates to a carbonization product comprising biocarbon formed in the system of the present disclosure or using the method of the present disclosure.

### BACKGROUND

Traditionally, organic material of different types has been known to be converted to charcoal or biocarbon using various processes. In most such processes the organic material is heated in an oxygen deficient or anaerobic atmosphere and the organic material is converted to char in a pyrolysis process.

However, performing pyrolysis at an industrial scale in an inert atmosphere to prevent combustion presents numerous technical challenges including heat transfer limitations and the production of undesirable tars and liquid products. The requirement for operating in an inert atmosphere adds significant mechanical complexity and limits overall reaction rates.

### SUMMARY

A system for carbonizing organic material is disclosed. The system may comprise:
a. a means for adding organic feedstock to a carbonization reactor,
b. a means for adding a gas comprising oxygen to the carbonization reactor,
c. a means for removing an oxygen-deficient gas from the carbonization reactor,
d. a means for initiating an exothermic reaction in the carbonization reactor, and
e. a means for removing a carbonization product from the carbonization reactor.

A method for carbonizing organic material is also disclosed. The method may comprise:
a. providing an organic feedstock to a carbonization reactor,
b. providing a gas comprising oxygen to the carbonization reactor,
c. initiating an exothermic reaction in the carbonization reactor, and
d. removing a carbonization product from the carbonization reactor.

Such a system and a method may be arranged for a carbonization reaction that occurs in biomass during the time it traverses the reactor, e.g. by passing from the top of the reactor to the bottom, e.g. to a perforated cone thereat. The biomass can thus be entered into the carbonization reactor as the organic feedstock, or a part thereof, and removed as the carbonization product.

At least two temperature sensors can be mounted at different heights of the carbonization reactor, or carbonization canister, in the so-called reactor particular to monitor the temperature within the biomass bed. This can be done in order to monitor the progression of the carbonization reaction. In an embodiment, the sensors are thermocouples. In an embodiment, there are at least four temperature sensors at different heights. In an embodiment, there are at least two temperature sensors at each height, e.g. four temperature sensors or more. They may be positioned encircling the inside of the carbonization reactor. In an embodiment, one or more of the sensors are positioned as upper sensor(s) above a designated location for a reaction front and one or more of the sensors are positioned as lower sensor(s) below the designated location for the reaction front. The system and method may thus be arranged to maintain the reaction front, at least relatively, stationary in the vertical direction of the reactor, in particular by monitoring the temperature at the upper sensor(s) and at the lowers sensor(s). The at least two temperature sensors mounted at different heights of the carbonization reactor may be utilized, in particular for obtaining repeated and/or continuous temperature measurements from the carbonization reactor.

Further, a carbonization product comprising biocarbon formed in the system of the present disclosure or using the method of the present disclosure is disclosed.

### BRIEF DESCRIPTION OF THE DRAWINGS

The accompanying drawing, which is included to provide a further understanding of the embodiments and constitute a part of this specification, illustrates various embodiments. In the drawings:

FIG. 1 presents a block diagram of the primary components of a system for carbonizing organic material according to the present disclosure.

FIG. 2 presents a system for carbonizing organic material according to an embodiment of the present disclosure.

FIG. 3 presents a system for carbonizing organic material according to an embodiment of the present disclosure.

FIG. 4 presents temperature measurements over time in a system for carbonizing organic material according to an embodiment of the present disclosure.

FIG. 5 presents reactant weight loss over time in a system for carbonizing organic material according to an embodiment of the present disclosure.

FIG. 6 presents a system for carbonizing organic material according to an embodiment of the present disclosure.

FIG. 7 presents another system for carbonizing organic material according to an embodiment of the present disclosure.

FIG. 8 presents a system for carbonizing organic material according to an embodiment of the present disclosure, in particular for energy recovery.

### DETAILED DESCRIPTION

A system for carbonizing organic material is disclosed. The system may comprise:
a. a means for adding organic feedstock to a carbonization reactor,
b. a means for adding a gas comprising oxygen to the carbonization reactor,
c. a means for removing an oxygen-deficient gas from the carbonization reactor,
d. a means for initiating an exothermic reaction in the carbonization reactor, and
e. a means for removing a carbonization product from the carbonization reactor.

As used herein, the term “carbonization” refers to increasing the ratio of carbon to oxygen in the product relative to the starting organic feedstock. In certain embodiments, the term carbonization may refer to the conversion of an organic feedstock to a material consisting essentially of pure carbon. In certain embodiments, the term carbonization may refer to the conversion of an organic feedstock to charcoal, biochar, or biocarbon.

In certain embodiments, the system may be arranged to operate in a continuous or semi-batch manner.

In certain embodiments, the internal volume of the carbonization reactor is at greater than atmospheric pressure during the carbonization reaction.

In certain embodiments, addition of feedstock to the carbonization reactor is performed at greater than atmospheric pressure.

As used herein, “greater than atmospheric pressure” refers to an absolute pressure of more than 1.01325 bar.

In certain embodiments, the pressure in the carbonization reactor may be between 3 and 20 bar. In certain embodiments, the organic feedstock is added to the carbonization reactor in a continuous manner.

As used herein, the term “continuous manner” refers to the addition of feedstock while the exothermic reaction is underway. Similarly, as used herein, the term “semi-batch manner” refers to the addition of feedstock before the initiation of the exothermic reaction. In certain embodiments, the carbonization product is removed from the carbonization reactor in a continuous or semi-batch manner.

In certain embodiments, the oxygen-deficient gas leaving the reactor is comprised of
0-60% nitrogen
10-50% CO₂
0-50% H₂
10-50% CO
0-20% CH₄
0-5% Ethane
0-5% Ethylene
0-5% Heavier hydrocarbons

In certain embodiments, the oxygen deficient gas comprises less than 5% O₂.

As used herein, the term “heavier hydrocarbons” refers to hydrocarbons consisting of three or more carbon atoms. Non-limiting examples of heavier hydrocarbons are propane, butane, propene, and butene.

As used herein, all percentages refer, unless explicitly stated otherwise, to a molar percentage of the composition.

In certain embodiments, the gas comprising oxygen is added to the carbonization reactor at greater than atmospheric pressure. In certain embodiments, the gas comprising oxygen may be air. In certain embodiments, the gas comprising oxygen may be a gas comprising more than 21% oxygen.

In certain embodiments, the gas comprising oxygen contains less than 21% oxygen. In certain embodiments, the gas comprising oxygen may be a gas where at least a portion of said gas originates from the oxygen-deficient gas outlet of a carbonization reactor.

In certain embodiments the gas comprising oxygen comprises less than 78% nitrogen.

In certain embodiments, the addition of organic feedstock is done at a rate to maintain a constant level of feedstock in the reactor. In certain embodiments, the rate of adding feedstock can be adjusted during the process to maintain an efficient carbonization process in the reactor. In one embodiment, the adding of feedstock is done under pressure. In one embodiment, the reactor maintained at than atmospheric pressure when feedstock is added.

In certain embodiments, the organic feedstock as may be derived from a biological process such photosynthesis or chemosynthesis. In other embodiments the organic feedstock is derived from a fossil fuel such as plastic or rubber.

In certain embodiments, the organic feedstock is mixed with an inorganic material prior to addition to the reactor. In one embodiment, the feedstock is wet impregnated with an aqueous solution of an inorganic salt prior to addition to the reactor. In one embodiment, the feedstock is wet impregnated with an aqueous solution containing a metal salt prior to addition to the reactor.

In certain embodiments, the means for initiating an exothermic reaction in the carbonization reactor is located at the opposite end of the carbonization reactor relative to the input of the gas comprising oxygen.

In certain embodiments, the means for initiating an exothermic reaction in the carbonization reactor is an electric heating source. In certain embodiments, the means for initiating an exothermic reaction in the carbonization reactor may be any other means suitable for initiating the reaction. Non-limiting examples of suitable means are burners burning liquid or gaseous fuels.

In one embodiment, the energy required to initiate an exothermic reaction in the reactor is provided by leaving a remainder of the hot product in the bottom of the container.

In certain embodiments, the carbonization product is continuously removed from the carbonization reactor. In one embodiment, the reactor is maintained at higher than atmospheric pressure when removing the carbonization product. In one embodiment, the carbonization product is cooled or quenched with water during removal.

In certain embodiments, the pressure of the reactor is maintained by controlling the flow of the oxygen comprising gas relative to the flow of the oxygen-deficient gas.

In certain embodiments, the flow of oxygen comprising gas is controlled by adjusting the pressure of the oxygen comprising gas relative to the pressure of the carbonization reactor.

In an embodiment, the biomass to be carbonized is fed into the carbonization reactor from the means for adding organic feedstock to a carbonization reactor, such as a biomass hopper, for example at the top of the carbonization reactor, and the passage of the biomass into and out of the means for adding organic feedstock to a carbonization reactor is controlled by isolation valves mounted above and below the means for adding organic feedstock to a carbonization reactor that allow biomass to be fed into the reactor at above atmospheric pressure. Such valves can be used to prevent pressure from leaking out of the carbonization pressure reactor. The means for adding organic feedstock to the carbonization reactor may be provided as a feedstock supply channel, which may comprise a supply screw and/or a supply conveyor belt for moving the feedstock to the reactor. In a system under continuous operation, the means for adding organic feedstock to the carbonization reactor, or the feedstock supply channel in particular, may be exposed to the carbonization reactor during operation, for example at all times.

In an embodiment, the means for removing a carbonization product from the carbonization reactor transport it to a storage container, the passage of the carbonization product into the storage container being controlled by an isolation valve.

As an example, the carbonization reactor comprises a perforated cone, for example at the lower end. It may collect the biomass and stops it from falling to the bottom of the reactor. A feeding means may remove carbonization product from the reactor, for example at the bottom of the perforated cone, and transport it to a storage container. The passage of the carbonization product into the storage container may be controlled by an isolation valve. An isolation valve on the outlet of the product storage container allows the carbonization product to be removed from the pressurized system.

Using isolation valves allows the reactor to be loaded and/or unloaded with increased speed. This may be particularly facilitating for the continuous operation. One or more isolation valve(s) may be arranged for pressure isolation for adding the organic feedstock to the carbonization reactor and/or for removing the carbonization product from the carbonization reactor. One or more isolation valve(s) may be arranged for temperature isolation, in particular for removing the carbonization product from the carbonization reactor.

In an embodiment, the system is arranged to maintain the reaction front, at least relatively, stationary in the vertical direction of the reactor, for example at a designated location (e.g. a designated elevation or a designated region, for example between a minimum elevation and a maximum elevation). For this purpose, the system may be arranged to monitor the progression of the carbonization reaction, in particular by temperature monitoring. In order to monitor the progression of the carbonization reaction, at least two temperature sensors can be mounted at different heights of the carbonization reactor to monitor the temperature within the reactor, in particular within the biomass bed.

In an embodiment, the system comprises at least two temperature sensors (below also “the sensors”), such as thermocouples, which may be mounted at different heights of the carbonization reactor in order to monitor the progression of the carbonization reaction. A first temperature sensor of the sensors may be mounted above a designated location for the reaction front, e.g. as defined above. A second temperature sensor of the sensors may be mounted below a designated location for the reaction front, e.g. as defined above. The sensors may be utilized to determine one or more estimated temperatures for the carbonization reaction, for example as an average of the temperature values determined by the sensors. The one or more estimated temperatures may also simply comprise a first estimated temperature as a measured temperature of the first temperature sensor and a second estimated temperature as a measured temperature of the second temperature sensor. When reaction gas is provided to the reactor from above, the temperature can be monotonously decreasing downwards in the reactor so that already two sensors can be utilized to monitor the progression of the carbonization reaction and determine limits for operation. However, three or more temperature sensors may be used to improve the detail for monitoring the progression.

In an embodiment, the system is arranged to provide a control instruction for removing carbonization product from the reactor when an estimated temperature for the carbonization reaction, for example as defined above, is above a first threshold temperature. This can be done, for example, when the temperature measured by the first or the second temperature sensor, or their average, is larger than the second threshold temperature.

In an embodiment, the system is arranged to provide a control instruction for adding organic feedstock to the reactor when an estimated temperature for the carbonization reaction, for example as defined above, is below a second threshold temperature. This can be done, for example, when the temperature measured by the first or the second temperature sensor, or their average, is smaller than the second threshold temperature.

The first threshold temperature may be larger than the second threshold temperature. As an example, the first threshold temperature may be 600-700 degrees Celsius. As an example, the second threshold temperature may be 500-600 degrees Celsius.

The system may be arranged to automatically add the organic feedstock and/or remove the carbonization product based on the control instruction. This may be done under continuous operation of the system.

In an embodiment, the system is arranged to cool or quench the carbonization product with water during removal.

In an embodiment, the system is arranged for cooling the carbonization product at the carbonization reactor and/or the removing at means for the carbonization product from the carbonization reactor, for example at a feeding means, e.g. at a product discharge channel, for removing the carbonization product from the reactor. For this purpose, the system may comprise a cooler arranged to apply cooling fluid, in particular water, at the carbonization product at the at the carbonization reactor and/or at the means for removing the carbonization product from the carbonization reactor. The cooling fluid be may delivered into the carbonization reactor and/or the means for removing a carbonization product from the carbonization reactor, e.g. into the product discharge channel. The cooler may be, for example, a spray cooler arranged to spray the cooling fluid at the carbonization product. The system may comprise also means for carrying away steam from the cooling. These means may include piping connected to the carbonization and/or the means for removing the carbonization product from the carbonization reactor for carrying away steam from the cooling.

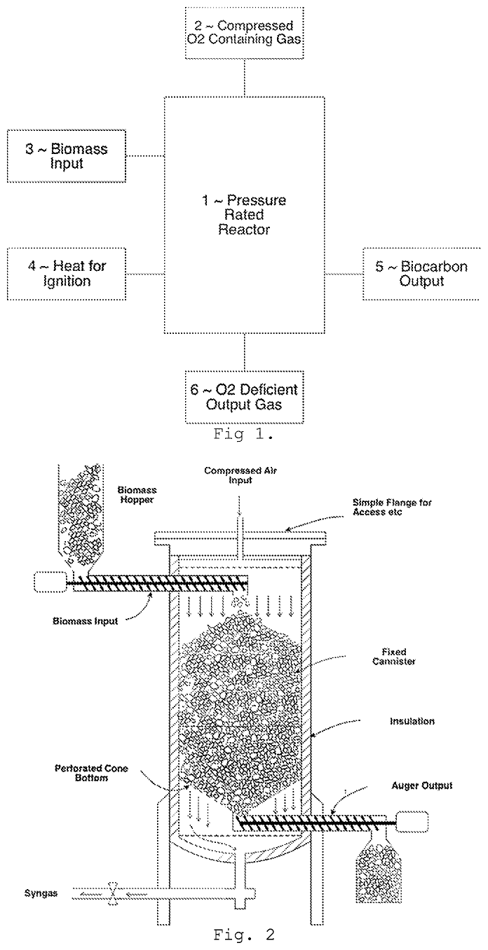

One embodiment of a system for carbonizing organic material is described in schematic form in FIG. 1. A system according to FIG. 1 comprises:
1. A pressure rated reactor,
2. An input for a compressed gas comprising oxygen,
3. An input for a biomass feedstock,
4. A means for inputting energy to initiate an exothermic reaction in the reactor.
5. An output for the carbonization product, and
6. An output for the oxygen-deficient gas.

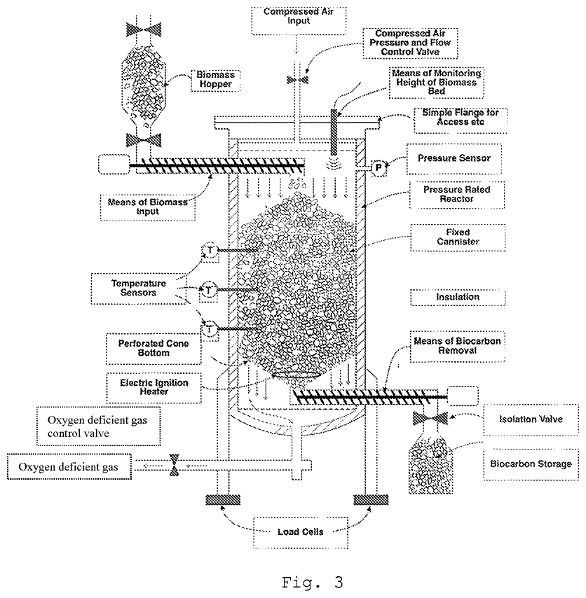

One embodiment of a system for carbonizing organic material is described in in FIG. 2. A system according to FIG. 2 comprises a fixed reactor wherein the reactor walls include insulation. The reactor is open at the top and is closed before operation with a sealable, air-tight lid that, when sealed, can withstand internal pressures higher than atmospheric pressure. The lid of the reactor comprises an input for a gas comprising oxygen.

The biomass to be carbonized is fed into the reactor from a feedstock container at the top of the reactor using a suitable feeding means such as a screw or an auger. The feeding means feeds the biomass into the middle of the reactor so that it lands on top of the existing mass inside the reactor.

The reactor comprises a perforated cone at the lower end that collects the biomass and stops it from falling to the bottom of the reactor. The perforations in the cone allow the oxygen deficient gas to pass through but collect the carbonization product. At the bottom of the perforated cone, a feeding means removes carbonization product from the reactor and transports it to a storage container. The feeding means may be any suitable feeding means know to a skilled person such as a screw feeder or an auger. The oxygen deficient gas collected from the bottom of the reactor may be combusted for energy or used as a feedstock for a secondary process.

In one embodiment, the carbonization reaction occurs in the biomass during the time it passes from the top of the reactor to the perforated cone. In one embodiment, the reaction front remains relatively stationary in the vertical direction of the reactor and the biomass feedstock moves in a downward direction as the reaction progresses. In one embodiment, the reaction front is the thermal flame front of an exothermic reaction.

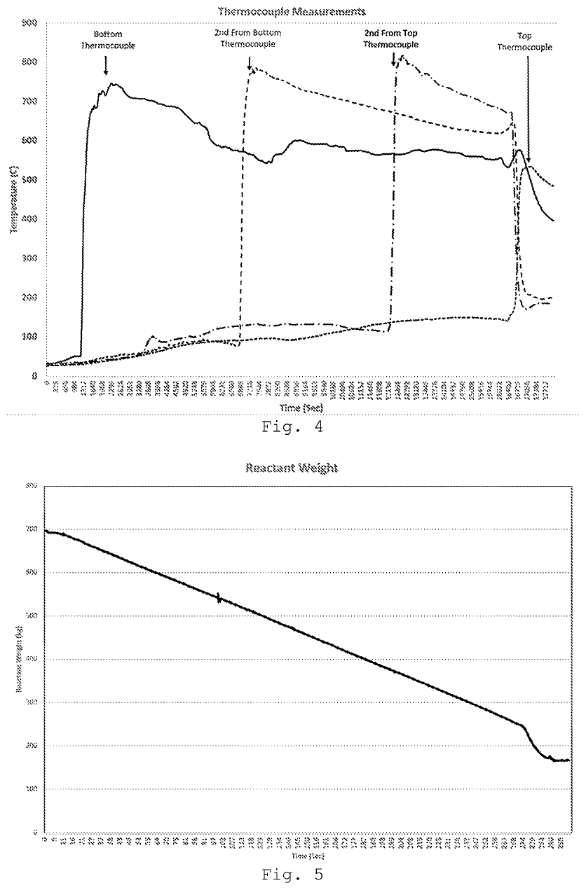

One embodiment of a system for carbonizing organic material is described in FIG. 3. A system according to FIG. 3 comprises a fixed reactor wherein the reactor walls include insulation. The reactor is open at the top and is closed before operation with a sealable, air-tight lid that, when sealed, can withstand internal pressures higher than atmospheric pressure. The reactor comprises an input for a gas comprising oxygen and a means for monitoring the height of the biomass bed. The reactor also comprises a pressure sensor mounted through the wall of the reactor at the upper end of the reactor, above the surface of the biomass bed.

The biomass to be carbonized is fed into the reactor from a biomass hopper at the top of the reactor using a suitable feeding means such as a screw or an auger. The passage of the biomass into and out of the biomass hopper is controlled by isolation valves mounted above and below the biomass hopper that allow biomass to be fed into the reactor at above atmospheric pressure. The feeding means feeds the biomass into the middle of the reactor so that it lands on top of the existing mass inside the reactor.

The reactor comprises a perforated cone at the lower end that collects the biomass and stops it from falling to the bottom of the reactor. The perforations in the cone allow the oxygen deficient gas to pass through but collect the carbonization product. At the bottom of the perforated cone, a feeding means removes carbonization product from the reactor and transports it to a storage container. The feeding means may be any suitable feeding means known to a skilled person such as a screw feeder or an auger. The passage of the carbonization product into the storage container is controlled by an isolation valve. An isolation valve on the outlet of the product storage container allows the carbonization product to be removed from the pressurized system. The oxygen deficient gas collected from the bottom of the reactor may be combusted for energy or used as a feedstock in a secondary process.

In one embodiment, the carbonization reaction occurs in the biomass during the time it passes from the top of the reactor to the perforated cone at the bottom. In order to monitor the progression of the carbonization reaction, at least two temperature sensors are mounted at different heights of the carbonization reactor canister to monitor the temperature within the biomass bed. In one embodiment, the reaction front remains relatively stationary in the vertical direction of the reactor and the biomass feedstock moves in a downward direction as the reaction progresses. In one embodiment, the reaction front is a thermal front created by the flame front of an exothermic reaction.

In certain embodiments, the removal of the oxygen deficient gas is controlled by a control valve.

In certain embodiments, mechanical energy is recovered from the oxygen deficient gas as it is reduced in pressure. In one embodiment mechanical energy is recovered from the oxygen deficient gas and used to increase the pressure of the gas comprising oxygen.

The energy recovery may be performed by routing the oxygen deficient gas, which may be at high pressure, to a turbine of the system for recovering the energy. In general, it may be performed by any of the means available to a person skilled in the art of energy recovery.

The system described in the current specification has the added utility of having properties suitable for the continuous or semi-batch carbonization of organic material. Operating the system in a continuous or semi-batch fashion eliminates the need for frequent loading and unloading of material to be carbonized as well as the carbonization product. Eliminating the need for frequent loading and unloading of material to be carbonized as well as the carbonization product enables running the carbonization for longer continuous time periods without the need for stopping the process for loading or unloading material.

As the carbonization in the system of the present disclosure operates in an atmosphere comprising oxygen, it also eliminates the need for evacuating the system prior to use or introducing an inert gas in the system.

A method for carbonizing organic material is disclosed. The method may comprise:
a. providing an organic feedstock to a carbonization reactor,
b. providing a gas comprising oxygen to the carbonization reactor,
c. initiating an exothermic reaction in the carbonization reactor,
d. removing a carbonization product from the carbonization reactor, and
e. removing an oxygen deficient gas from the carbonization reactor.

In certain embodiments, the carbonization is performed in a continuous or semi-batch manner.

In certain embodiments, the organic feedstock is fed into the carbonization reactor at greater than atmospheric pressure.

In certain embodiments, the oxygen-deficient gas comprises
0-60% nitrogen
10-50% CO₂
0-50% H₂
10-50% CO
0-20% CH₄
0-5% Ethane
0-5% Ethylene
0-5% Heavier hydrocarbons.

In certain embodiments, the oxygen deficient gas comprises less than 5% oxygen.

In certain embodiments, the gas comprising oxygen is added to the carbonization reactor at greater than atmospheric pressure.

In certain embodiments, the gas comprising oxygen may be air. In certain embodiments, the gas comprising oxygen may be a gas comprising more than 21% oxygen. In certain embodiments, the organic feedstock is added to the carbonization reactor in a continuous manner.

In certain embodiments, the organic feedstock is mixed with an inorganic material prior to addition to the reactor.

In certain embodiments, the carbonization product is removed from the carbonization reactor in a continuous or semi-batch manner.

In certain embodiments, the addition of organic feedstock is done at a rate to maintain a constant level of feedstock in the reactor.

In certain embodiments, the carbonization product is continuously removed from the carbonization reactor.

A carbonization product produced in the system of the present disclosure or using the method of the present disclosure is disclosed.

In certain embodiments, the carbonization product is biochar or biocarbon. In certain embodiments the carbonization product is electrically conductive. In certain embodiments, the carbonization product may be activated carbon or activated biocarbon. In certain embodiments, the carbonization product may be subjected to activation to form activated carbon or activated biocarbon using any suitable activation treatment known to a person skilled in the art.

In certain embodiments, the carbonization product may be further enhanced by the inclusion of inorganic compounds or compositions in the product.

The method described in the current specification has the added utility of having properties suitable for the continuous or semi-batch carbonization of organic material. Operating the method in a continuous or semi-batch fashion eliminates the need for frequent loading and unloading of material to be carbonized as well as the carbonization product.

As the carbonization according to the method of the present disclosure operates in an atmosphere comprising oxygen, it also eliminates the need for evacuating the system prior to use or introducing an inert gas in the system.

A carbonization product comprising biocarbon formed in the system of the present disclosure or using the method of the present disclosure is also disclosed herein.

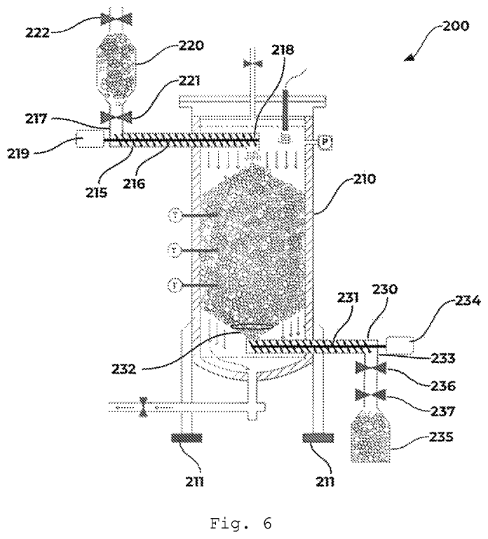

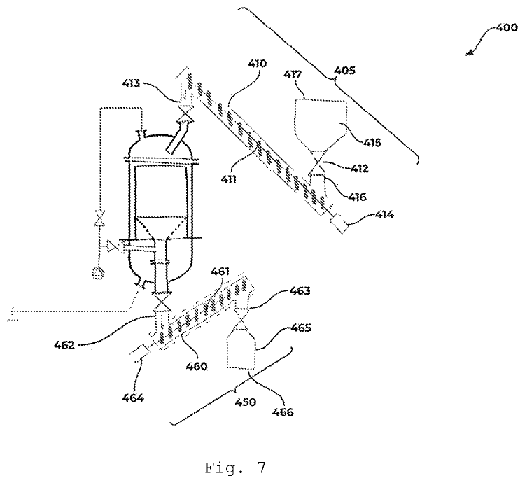

Continuous operation for the system may be supported in various ways. In particular, a feeding seal arrangement may be provided as a gas-tight seal arrangement for continuous, e.g. constant, feed of material inside the reactor. This can be done without lowering the pressure and/or temperature inside the reactor, allowing a continuous process for production of the carbonization product, such as biochar. The feeding seal arrangement may comprise a double dump valve and/or a pressure (and optionally temperature) resistant special airlock rotary valve. The feeding seal arrangement may also comprise a plug screw feeder. Alternatively or additionally, a discharging seal arrangement t may be provided as a gas-tight seal arrangement for continuous, e.g. constant, discharge of material from the reactor without lowering the pressure and/or temperature inside the reactor, allowing a continuous process for production of the carbonization product, such as biochar. The discharging seal arrangement may comprise double dump valve and/or a pressure (and optionally temperature) resistant special airlock rotary valve. The discharging seal arrangement may also comprise a plug screw feeder. FIG. 6 illustrates one embodiment of a system 200 for carbonizing organic material. The system may comprise any or all of the features as described above. The system comprises the reactor 210, which may be provided as a pressure rated vessel. The reactor may be mounted upon one or more load cells 211 for measurement of the mass of the reactor and/or contents, or any predetermined affixed components.

The system may comprise the (first) feeding means for feeding the biomass to be carbonized into the reactor. These may comprise a feedstock supply channel 215 such as a feedstock supply tube, which may be mounted to the reactor 210, preferably at a location above the midpoint of the reactor volume. The feeding means may be arranged to pass through the wall of the reactor, which may be pressurized, to allow material to be moved from outside the reactor 210 inside of the reactor 210 and allow operation at elevated pressures. The feedstock supply channel 215 may comprise a supply screw 216 and/or a supply conveyor belt for moving the feedstock to the reactor. The feeding means may also comprise one or more supply motors 219 for rotating the supply screw 216 and/or propelling the supply conveyor belt. It may comprise a supply feed port 217 and supply exit port 218. These feeding means may also comprise a feedstock storage vessel 220, which can further comprise a feedstock bottom isolation valve 221 and/or a feedstock top isolation valve 222. Either or both of these are preferably gate valves allowing solids to easily pass across the valve when in the open position.

The system may comprise the (second) feeding means for removing the carbonization product from the reactor. These may comprise a product discharge channel 230 such as a product discharge tube 230, which may be mounted to the reactor 210, preferably at a location below the midpoint of the reactor volume. The feeding means may be arranged to pass through the wall of the reactor, which may be pressurized, to allow material to be moved from inside of the reactor 210 outside of the reactor 210 and allow operation at elevated pressures and temperatures. The product discharge channel 230 may comprise a discharge screw 231 and/or a discharge conveyor belt for moving the carbonization product from the reactor. The feeding means may also comprise one or more discharge motors 234 for rotating the discharge screw 231 and/or propelling the discharge conveyor belt. It may comprise a discharge feed port 232 and a discharge exit port 233. These feeding means may also comprise a product storage vessel 235, which can further comprise a first product isolation valve 236 and/or a second isolation valve 237. Either or both of these are preferably gate valves allowing solids to easily pass across the valve when in the open position.

In an embodiment, the first isolation valve 236 and second isolation valve 237 are used during operation to allow continuous removal of the carbonization product by first having both the first isolation valve 236 and second isolation valve 237 in the open position, filling the product storage vessel 235. Subsequently, for example after the product storage vessel 235 is filled to a predetermined volume, the second isolation valve 237 is closed and maintained as such while the product storage vessel 235 is emptied and resealed. Then, the second isolation valve 237 is reopened allowing product filling the volume between the valves to move into the product storage vessel 235. Preferably, the position of the product storage vessel 235 is lower than the discharge exit port 233 such that gravity can be used to cause product to move from the discharge exit port 233 into the product storage vessel 235.

FIG. 7 illustrates one embodiment of a system 400 for carbonizing organic material. The system may comprise any or all of the features as described above. A specific embodiment of the (first) feeding means 405 for feeding the biomass to be carbonized into the reactor is disclosed, e.g. as an auger feedstock supply system.

The system 400, or the feeding means 405 thereof, includes a primary supply channel 410, such as a supply tube, that contains a supply feed port 412 and a supply exit port 413. It may also comprise a supply transporter 411, such as a supply screw and/or a supply conveyor belt, for moving the feedstock to the reactor. It may comprise one or more supply motors 414 for rotating the supply screw and/or propelling the supply conveyor belt. It may comprise a feedstock storage vessel 415.

The primary supply channel 410 can be a seamless tube. It may be comprised of a metallic material. It can be made thick enough to withstand the expected operating pressures and maintain operating stability at elevated temperatures, with appropriate safety margins. The supply feed port 412 can be connected to the feedstock storage vessel 415. It can be configured to allow gravity to pull feedstock down into primary supply channel 410. A vibration system may be included to help material flow from the feedstock storage vessel 415 into the primary supply tube 410. Optionally, mechanical fingers and/or other features may be included to encourage material flow free of binding jams or other events that prevent free flow of material.

In one embodiment, the feedstock storage vessel 415 has, for example at its base, a supply isolation valve 416 between the feedstock storage vessel 415 and the supply feed port 412. The vessel may also have an openable feedstock hopper lid 417, such that the feedstock storage vessel 415 can be isolated. The feedstock storage vessel 415 can be arranged to provide a pneumatic seal to prevent gas leakage from the reactor during operation, while allowing feedstock to be delivered to the reactor at elevated operating pressures. The feedstock hopper lid 417 may be mounted on a hinge. It may be connected with one or more actuators, such as hydraulic or pneumatic cylinders, so that it can be opened and closed on demand, for example remotely.

The feedstock storage vessel 415 may be designed to a limited size provided that the method used to fill the feedstock storage vessel 415 is faster than the time to discharge the contents of the primary supply tube 410 to maintain continuous operation. The supply motor(s) 414 may be arranged to operate with variable speeds such that the supply transporter 411 can be actuated quickly to move the newly charged feedstock to the supply exit port 413 quickly, to maintain continuous operation.

FIG. 7 also shows an embodiment of the (second) feeding means 450 for removing the carbonization product from the reactor, e.g. as an auger product discharge system. The means 450 include a primary discharge channel 460, such as a discharge tube, that contains a discharge feed port 462 and a discharge exit port 463. It may also comprise a discharge transporter 461, such as a discharge screw and/or a discharge conveyor belt, for moving the carbonization product from the reactor. It may comprise one or more discharge motors 464 for rotating the discharge screw and/or propelling the discharge conveyor belt. It may comprise a product storage vessel 465, such as a product hopper.

In one embodiment, the primary discharge channel 460 is similar in construction to the primary supply channel 410. In some embodiments, the primary discharge channel 460 is arranged to process the product at high temperatures can thus be arranged to handle high temperature solids. The discharge exit port 463 can connected to the product storage vessel 465. The feeding means may be configured to allow gravity to pull product down into the product storage vessel.

In one embodiment, the product storage vessel 465 has an isolation valve at its opening port, e.g. between the product storage vessel 465 and the discharge exit port 463. The product storage vessel may have an openable product hopper lid 466, such that the product storage vessel 465 can be isolated. The product storage vessel 465 can be arranged to provide a pneumatic seal to prevent gas leakage from the reactor during operation, while allowing the product to be discharged at elevated reactor operating pressures.

The product hopper lid 466 may be mounted on a hinge. It may be connected with one or more actuators, such as hydraulic or pneumatic cylinders, so that it can be opened and closed on demand, for example remotely. The product hopper lid 466 may be configured to open downward, such that the product within the product storage vessel 465 falls out due to gravity when the product hopper lid 466 is opened. The discharge screw motor 464 may be arranged for variable speed operation such that the discharge transporter 461 can be actuated at a speed to maintain a substantially constant level within the reactor during operation, to maintain continuous operation.

In one embodiment, the feeding system(s), i.e. the first and/or the second one, are made of all metallic components to allow high temperature operation. The first and/or the second feeding system may be cooled passively and/or actively, for example by means of gas and/or fluid, such as water. In one embodiment, the internal shaft and blades of the screws include enclosed channels into which a cooling fluid is circulated to provide cooling. In one embodiment, only the discharge system, i.e. the second feeding system, is actively cooled.

For cooling, a cooling fluid can be applied to the product to reduce the product temperature and decrease the probability of reaction with atmospheric air after exposure to air or other oxygen containing gas. For this purpose, water may be used as the cooling fluid for product cooling. It may comprise one or more types of minerals to control the amount of mineral deposits onto the product when the water is allowed to evaporate.

The fluid, such as water, can be applied in a manner that minimizes the mass of fluid present in the in the product after the cooling process. The fluid may be sprayed onto the product while, optionally, a cooling gas may be directed to flow over the product. The mass of fluid and cooling gas can be controlled so that a majority of the fluid evaporates and is carried away by the cooling gas such that the moisture does not condense onto the product. In one embodiment, purified water is used that has a mineral content of less than 100 ppm, such that only a small amount of minerals is deposited onto the product. Preferably, after the product is cooled, less than 200 grams of added water will be present in each kilogram of dry durable carbon product after the product is exposed to atmospheric air. More preferably, less than 100 grams of added water will be present in each kilogram of dry durable carbon after the product is exposed to atmospheric air. Most preferably, less than 50 grams of added water will be present in each kilogram of dry durable carbon after the product is exposed to atmospheric air. Added water is defined as the mass of water present in the product as compared to the product removed without water applied.

Cooling fluid may be introduced through direct fluid flow and/or as an aerosol. In one embodiment, a liquid delivery device is used to deliver fluid directly onto the solid product. A pipe, such as a metal pipe, may be installed within the reactor at the bottom of the reactor where the product has been formed and the reaction is complete or nearly complete. An aerosol nozzle, nebulizer, and/or other aerosolizing device may be used to create fluid droplets to be applied to the product alone or in combination with direct fluid application. Nitrogen or other inert gas may be used to produce aerosolized fluid droplets using a gas-aerosolizing nozzle. Air may be used as the aerosolizing gas but risks reaction with hot product that may react and reduce solid mass.

Alone or in combination with application of cooling fluid, thermal radiation can provide an exemplary mode of heat transfer at the temperatures where the solid carbon risks meaningful oxidation.

In select embodiments, cooling fluid such as water is used to cool the reactor and/or piping that holds the product, prior to exposure to air. Cooling of the reactor can reduce the temperature of the product as heat is transferred to the reactor or other containment walls from the hot products, primarily through radiative and conductive heat transfer. In certain embodiments, a fixed flow rate of cooling fluid is used to flow onto the reactor outer wall on at least the lower portion of the reactor while the temperature of the cooling fluid collecting immediately after contacting the containment wall is monitored. The change in the temperature of the fluid can be used to estimate the temperature of the product and/or the heat transfer rate from the product. This can be used to determine when the product can be safely removed from the reactor.

It is further noted that there can be significant energy stored in the oxygen deficient gas exiting the reactor, for example in chemical bonds as well as mechanical and/or thermal form. In one embodiment, the thermal and/or mechanical energy is recovered in a process, first leaving an oxygen deficient gas that has a lower pressure and/or a lower temperature than at the point prior to exiting the reactor. In some embodiments, more than 20% of this thermo-mechanical energy can be recovered after it exits the reactor, or a main reactor body thereof.

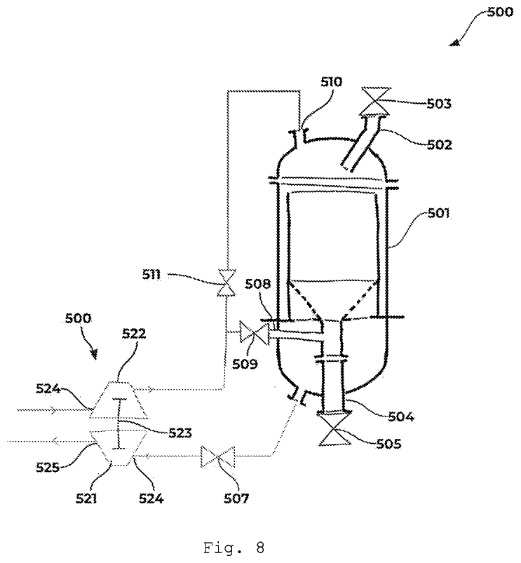

FIG. 8 illustrates one embodiment of a system 500 for carbonizing organic material. The system may comprise any or all of the features as described above.

The system 500 may include a thermo-mechanical energy recovery system. The system may include a carbonization reactor 501, e.g. as a reactor vessel, the means for adding organic feedstock to the carbonization reactor comprising a feedstock input port 502 and, optionally a feedstock inlet port isolation valve 503, the means for adding a gas comprising oxygen to the carbonization reactor comprising a gas inlet port 510 and, optionally, a gas inlet port isolation valve 511, the means for removing an oxygen-deficient gas from the carbonization reactor comprising a gas exhaust port 506 and, optionally, a gas exhaust port isolation valve 507 and the means for removing a carbonization product from the carbonization reactor comprising a solids exhaust port 504 and, optionally, a solids exhaust port isolation valve 505. Furthermore, the system may comprise a gas auxiliary port 508 and, optionally, a gas auxiliary port isolation valve 509.

The system 500 may comprise a turbocharger assembly 520. The turbocharger assembly 520 can include an expander section 521 and a compressor section 522, where the two sections may be connected, for example by a mechanical linkage 523. In operation, the expander section 521 may be arranged to receive oxygen deficient gas at elevated pressure and temperature from the gas exhaust port 506, for example through gas piping. Within the expander section 521 of the turbocharger assembly 520, the thermo-mechanical energy within the exhaust gases can be transformed into kinetic energy, for example to a rotating kinetic energy of expander rotating blades. This can cause movement, such as rotation, of the connected mechanical linkage 523 to provide the power to compress the inlet gases, as is known in the art of turbocharging systems. The compressor section 522 can be arranged to receive power from the mechanical linkage 523 and rotate blades within the section. Oxygen rich fluids such as atmospheric air and/or other fluids from storage tanks or other storage means can be supplied to a compressor section inlet port 524. In an embodiment, atmospheric air may be used and dried to a controlled dew point, for example to a dew point of less than −20 degrees Celsius, for example with gas drying equipment prior to entering the turbocharger inlet port. After the gas enters the compressor section 522, it may be arranged to contact the rotating blades and is increased in pressure and/or temperature. In some embodiments, the pressure of the oxygen rich gases is first increased by a compressor (not shown) prior to entry into the compressor section 522, such that the pressure of the fluids entering the reactor can be greater than the pressure capable of being supplied by the turbocharger assembly 520 acting alone.

After the oxygen deficient gas enters the compressor section 522 and provides energy for compression, it can be arranged to exit the compressor section 522 at the compressor section exhaust port 525 at a lower pressure and temperature than entry. It can then be further processed for energy recovery. In one embodiment, the residual thermal energy is collected though a heat exchanger. It can then be used, for example, to provide heat for drying feedstock of the reactor. In another embodiment, no further direct recovery of residual thermo-mechanical energy is attempted. It may, however, be recovered indirectly as part of the chemical energy recovery process.

Recovery of the chemical energy oxygen deficient gas may be accomplished immediately after exiting the reactor or after the thermo-mechanical energy has been extracted to the designed level. The oxygen deficient gas has a large amount of stored energy in the form of chemical bonds, that can be released by reacting in a chemical process. In one embodiment, the energy is released by reacting the oxygen deficient gas with oxygen contained in atmospheric air in a combustion reaction.

The chemical energy content of the oxygen deficient gas on a dry basis may be at least 4 megajoules per kilogram (MJ/kg) or preferably at least 5.5 MJ/kg. In an embodiment, atmospheric air can be used as the reactant gas. The associated nitrogen may remain present in the oxygen deficient gas. The concentration of nitrogen in the oxygen deficient gas can be less than 60% by volume, and preferably less than 50% by volume.

In one embodiment, wood pellets are used as the feedstock. They may have a moisture content of less than 20%. On a dry basis, the oxygen-deficient gas leaving the reactor may be comprised of
Less than 50% nitrogen
15-25% CO2
10-20% H2
10-20% CO
Less than 10% CH4
Less than 5% Ethane
Less than 2% Ethylene
Less than 5% All Heavier hydrocarbons

The amount of residual oxygen contained within the oxygen deficient gas can be low, as it is consumed during reaction. In an embodiment, oxygen (O2) may comprise less than 5% by volume of the dry oxygen deficient gas, preferably O2 less than 2% by volume and more preferably O2 less than 0.5% by volume.

In one embodiment, oxygen deficient gas is combined with oxygen rich fluid(s) such as atmospheric air. These can be supplied through a blower, pump, compressor, and/or other device to increase pressure to allow supply flow and/or other fluids from storage tanks or other storage means. In an embodiment, atmospheric air is used. In one embodiment, oxygen deficient gas is combined with atmospheric air inside of a boiler combustion chamber in a boiler heat transfer system, where it can increase the temperature and/or pressure of the boiler working fluid to provide heat for a building or other facility or purpose, as is known in the art of boiler systems. Other types of heat transfer systems may be used, provided they are compatible with the oxygen deficient gases provided by the reaction process.

### Examples

Reference will now be made in detail to various embodiments.

The description below discloses some embodiments in such a detail that a person skilled in the art is able to utilize the embodiments based on the disclosure. Not all steps or features of the embodiments are discussed in detail, as many of the steps or features will be obvious for the person skilled in the art based on this specification.

### Example

693 kg of olive pit with a moisture content of 8.5 wt.-% containing approximately 332 kg of organic carbon was added to the carbonization reactor. The reactor was pressurized to 400 kPa with compressed air from a pressure regulated source. The reactor was checked for leaks and the outlet valve opened to allow approximately 8 m³/h of air to flow through the reactor. An electric heating coil at the bottom of the reactor was initiated for 5 minutes. Initiation of the carbonization reaction was evidenced by a rapid increase in reactor pressure that prevented the ingress of air from the regulated supply. The outlet valve was then opened to reduce the pressure in the reactor. When the reactor pressure dropped below 400 kPa a controlled flow of air was added to the reactor to maintain a stable flow rate of air into the reactor while maintaining 400 kPa of pressure within the reactor. Using the outlet valve and air control valves the flow of air was increased to 68 m³/h while maintaining 400 kPa in the reactor. The carbonization reaction is characterized by an exothermic thermal wave that propagates from the bottom of the reactor to the top over the span of 289 minutes as evidenced by the 4 rows of thermocouples spaced equidistantly from the bottom to the top of the reactor (FIG. 4). Further evidence of the linear nature of the reaction is evidenced by a steady weight loss measured by load cells mounted beneath the reactor (FIG. 5). The yield of carbon product was 165 kg. Independent analysis of the product revealed a carbon content of 91.7%, atomic H:C ratio of 0.19% and atomic O:C ratio of 0.024%.

It is obvious to a person skilled in the art that with the advancement of technology, the basic idea may be implemented in various ways. The embodiments are thus not limited to the examples described above; instead, they may vary within the scope of the claims.

The embodiments described hereinbefore may be used in any combination with each other. Several of the embodiments may be combined together to form a further embodiment. A method or a system, disclosed herein, may comprise at least one of the embodiments described hereinbefore. It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items. The term “comprising” is used in this specification to mean including the feature(s) or act(s) followed thereafter, without excluding the presence of one or more additional features or acts.

1. A system for carbonizing organic material, wherein the system comprises:
a. a means for adding organic feedstock to a carbonization reactor,
b. a means for adding a gas comprising oxygen to the carbonization reactor,
c. a means for removing an oxygen-deficient gas from the carbonization reactor,
d. a means for initiating an exothermic reaction in the carbonization reactor, and
e. a means for removing a carbonization product from the carbonization reactor;
wherein:
the system comprises at least two temperature sensors mounted at different heights of the carbonization reactor,
the system comprises a turbocharger assembly comprising an expander section and a compressor section and the expander section is arranged to receive the oxygen-deficient gas at elevated pressure and temperature from the carbonization reactor via a gas exhaust port,
the system comprises means for adding the organic feedstock to the carbonization reactor, for example a feedstock supply channel,
the carbonization reactor comprises a perforated cone at its lower end, and/or
the systems is provided with a heat exchanger to collect residual thermal energy from the oxygen-deficient gas removed from the carbonization reactor.

2. The system of claim 1, wherein the system is arranged to operate in a continuous or semi-batch manner.

3. (canceled)

4. (canceled)

5. (canceled)

6. (canceled)

7. (canceled)

8. (canceled)

9. (canceled)

10. (canceled)

11. The system of claim 1, wherein the means for initiating an exothermic reaction in the carbonization reactor is located at the opposite end of the carbonization reactor relative to the input of the gas comprising oxygen.

12. The system of claim 1, wherein the means for initiating an exothermic reaction in the carbonization reactor is an electric heating source.

13. (canceled)

14. (canceled)

15. (canceled)

16. (canceled)

17. (canceled)

18. (canceled)

19. (canceled)

20. The system of claim 1 arranged to recover mechanical energy from the oxygen-deficient gas as it is reduced in pressure.

21. The system of claim 20 arranged to use the recovered mechanical energy to increase the pressure of the gas comprising oxygen.

22. A method for carbonizing organic material, wherein the method comprises:
a. providing an organic feedstock to a carbonization reactor,
b. providing a gas comprising oxygen to the carbonization reactor,
c. initiating an exothermic reaction in the carbonization reactor, and
d. removing a carbonization product from the carbonization reactor;
wherein:
the method comprises utilizing at least two temperature sensors mounted at different heights of the carbonization reactor,
the carbonization reactor comprises a turbocharger assembly comprising an expander section and a compressor section and, in operation, the expander section receives oxygen-deficient gas at elevated pressure and temperature from the carbonization reactor via a gas exhaust port,
the carbonization reactor comprises means for adding the organic feedstock to the carbonization reactor, for example a feedstock supply channel,
the carbonization reactor comprises a perforated cone at its lower end,
the internal volume of the carbonization reactor is at greater than atmospheric pressure during the carbonization reaction,
the organic feedstock is mixed with an inorganic material prior to addition to the reactor,
residual thermal energy is collected from the oxygen-deficient gas removed from the carbonization reactor though a heat exchanger, and/or
the carbonization product removed from the reactor is electrically conductive and/or is activated carbon or activated biochar.

23. (canceled)

24. (canceled)

25. (canceled)

26. (canceled)

27. (canceled)

28. (canceled)

29. (canceled)

30. (canceled)

31. The method of claim 22 comprising recovering mechanical energy from the oxygen-deficient gas as it is reduced in pressure.

32. The method of claim 31, wherein the recovered mechanical energy is used to increase the pressure of the gas comprising oxygen.

33. Carbonization product comprising biocarbon formed using the method of claim 22.

34. The system of claim 1, wherein the turbocharger is arranged to supply oxygen rich fluid to the compressor section via an inlet port and increase the pressure and/or temperature of the oxygen rich fluid.

35. The system of claim 1, wherein the feedstock supply channel comprises a supply screw and/or a supply conveyor belt for moving the feedstock to the reactor.

36. The system of claim 1, wherein the feedstock is wet impregnated with an aqueous solution of an inorganic salt prior to addition to the reactor.

37. The method of claim 22, wherein oxygen rich fluid is supplied to the compressor section via an inlet port and the oxygen rich fluid is increased in pressure and/or temperature.

38. The method of claim 22, wherein the feedstock supply channel comprises a supply screw and/or a supply conveyor belt for moving the feedstock to the reactor.

39. The method of claim 22, wherein the feedstock is wet impregnated with an aqueous solution of an inorganic salt prior to addition to the reactor.

40. The method of claim 22, wherein the feedstock is wet impregnated with an aqueous solution containing a metal salt prior to addition to the reactor.

41. The carbonization product of claim 33, wherein the carbonization product is biochar or biocarbon.

42. The carbonization product of claim 33, wherein the carbonization product is electrically conductive.

43. The carbonization product of claim 33, wherein the carbonization product may be activated carbon or activated biocarbon.
